(19) United States
(12) Patent Application Publication
(10) Pub. No.: US 2008/0037266 A1
(43) Pub. Date: Feb. 14, 2008

(54) Lit Running Board

(76) Inventor: Cole J. CUNNIEN, Canton, MI (US)

Correspondence Address: MAGNA INTERNATIONAL, INC., 337 MAGNA DRIVE, AURORA, ON, L4G-7K1, US

(21) Appl. No.: 11/835,566

(22) Filed: Aug. 8, 2007

Related U.S. Application Data
(60) Provisional application No. 60/836,992, filed on Aug. 9, 2006.

(51) Int. Cl. B60Q 1/32

(52) U.S. Cl. 362/495

(57) ABSTRACT

A running board assembly includes a frame having an interior and a top surface. The top surface of the frame includes at least one slot extending therethrough. A lightpipe step-strip includes a first portion disposed within the interior of the frame and a second portion mounted along the top surface of the frame. A lamp assembly is fixedly secured to the frame for transmitting light towards the lightpipe step-strip. The first portion of the lightpipe step-strip redirects light through the at least one slot in the frame to light the second portion of the lightpipe step-strip and provide nighttime visibility of the running board assembly.

### CROSS-REFERENCE TO RELATED APPLICATION

This application claims the benefit of and priority to U.S. Provisional Application Ser. No. 60/836,992, filed Aug. 9, 2006 and entitled “Lit Running Board.”

### BACKGROUND

1. Field of the Invention

The invention relates to running board assemblies. More particularly, the invention relates to running board assemblies including a lamp assembly for providing nighttime visibility.

2. Description of Related Art

Running boards are popular accessories for certain motor vehicles having a high ground clearance, such as pickup trucks and sport utility vehicles. It is desirable to illuminate these running boards to allow users to find a stepping surface thereof at night. Current lighted running boards utilize, however, lower cost lamps that provide uneven light distribution and result in glare to the user, which actually reduces visibility to the running board. In addition, current running board lamps are located in unprotected lower regions of the motor vehicle and are, as a result, susceptible to damage.

### SUMMARY

According to one aspect of the invention, a running board assembly includes a frame having all interior and a top surface. The top surface of the frame includes at least one slot extending therethrough. A lightpipe step-strip includes a first portion disposed within the interior of the frame and a second portion mounted along the top surface of the frame. A lamp assembly is fixedly secured to the frame for transmitting light towards the lightpipe step-strip. The first portion of the lightpipe step-strip redirects light through the at least one slot in the frame to light the second portion of the lightpipe step-strip and provide nighttime visibility of the running board assembly.

According to another aspect of the invention, a running board assembly includes a frame having opposing top and bottom surfaces defining an interior. The bottom surface includes at least one slot extending therethrough. A lightpipe step-strip is disposed within the interior of the frame and is visible through the at least one slot in the bottom surface. A lamp assembly is fixedly secured to the frame for transmitting light into the interior of the frame. The lightpipe-step strip redirects light from the interior of the frame to the portion of the lightpipe step-strip visible through the at least one slot to allow visibility of the area below the running board assembly.

### BRIEF DESCRIPTION OF THE DRAWINGS

The embodiments of the invention will be readily appreciated as the same becomes better understood by reference to the following detailed description when considered in connection with the accompanying drawings wherein:

FIG. 1 is a perspective view of a running board assembly according to one embodiment of the invention including a frame and a lamp assembly secured thereto;

FIG. 2 is a perspective view of the running board assembly including the frame defining an interior;

FIG. 3 is an exploded, perspective view of the running board assembly;

FIG. 4 is a perspective view, partially cut away, of the running board assembly including a lightpipe step-strip;

FIG. 5 is cross sectional view of the running board assembly taken along lines 5-5 in FIG. 1;

FIG. 6 is a planar section view of the running board assembly;

FIG. 7 is a planar section view of the running board assembly in FIG. 6 depicting light being redirected at the lightpipe step-strip;

FIG. 8 is a fragmentary, perspective view of the running board assembly when lit; and

FIG. 9 is a sectional view of a running board assembly according to another embodiment of the invention.

### DETAILED DESCRIPTION OF THE EMBODIMENTS

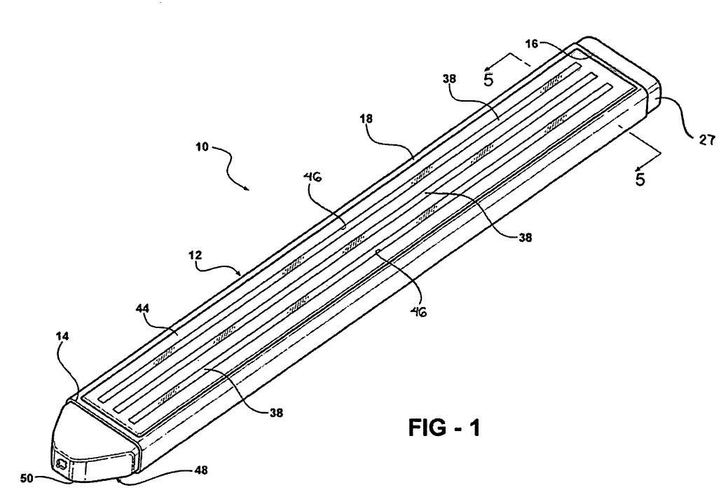

Referring to FIGS. 1 through 3, a running board assembly, generally shown at 10, is provided for a motor vehicle. The running board assembly 10 includes a frame, generally indicated at 12, extending longitudinally between opposing ends 14, 16. The frame 12 includes a top surface 18, a bottom surface 20, and spaced apart sidewalls 22, 24 extending between the top 18 and bottom 20 surfaces. The frame 12 also includes an interior 26 defined in part by the top 18 and bottom 20 surfaces and spaced apart sidewalls 22, 24. The frame 12 may be formed from steel. An end cap 27 is fixedly mounted to one end 16 of the frame 12.

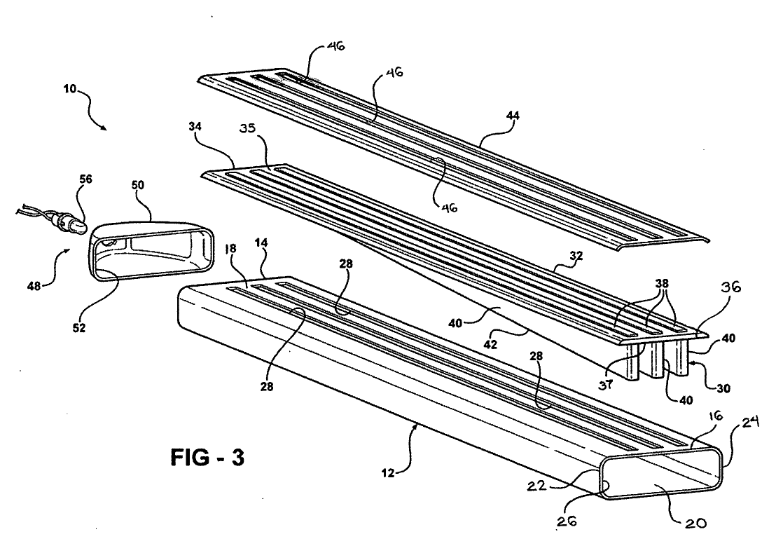

The top surface 18 defines at least one slot 28, shown in FIG. 3, extending therethrough and open to the interior 26 of the frame 12. In the current embodiment, there are three spaced apart slots 28 extending longitudinally between the opposing ends 14, 16 parallel to one another. It is, however, appreciated that the particular size, shape, number, and orientation of the slots 28 may vary.

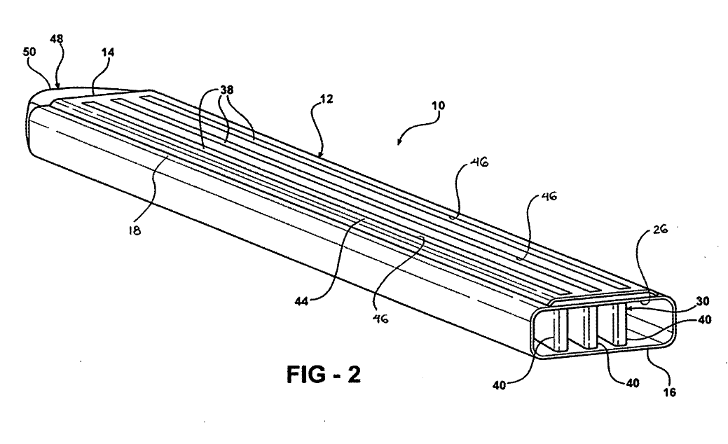

Referring to FIGS. 2 and 3, the running board assembly 10 also includes a lightpipe step-strip, generally indicated at 30, disposed within the interior 26 of the frame 12 and mounted along the top surface 18 thereof. The lightpipe step-strip 30 is a molded plastic article that is transparent and, as a result, capable of transmitting light. In one embodiment, the lightpipe step-strip 30 includes a plate 32 extending between first 34 and second 36 ends. The plate 32 includes an upper surface 35 and an opposing lower surface 37. At least one strip 38 extends along the plate 32. The at least one strip 38 is mounted along the upper surface 35 of the plate 32 and is raised relative thereto. In the current embodiment, there are three spaced apart strips 38 each extending longitudinally between the first 34 and second 36 ends.

The lightpipe step-strip 30 also includes at least one downwardly extending member 40 extending out from the lower surface 37 of the plate 32. In the current embodiment, the lightpipe step-strip 30 includes three spaced apart downwardly extending members 40 that are received within the respective three slots 28 of the frame 12 to couple the lightpipe step-strip 30 to the frame 12. When the downwardly extending members 40 are received within the respective slots 28, the downwardly extending members 40 are disposed within the interior 26 of the frame 12 and the lower surface 37 of the plate 32 of the lightpipe step-strip 30 abuts against the top surface 18 of the frame 12.

Each of the downwardly extending members 40 generally extends longitudinally between the first 34 and second 36 ends of the lightpipe step-strip 30. In the current embodiment, each of the downwardly extending members 40 includes a lower edge 42 that approaches the plate 32 as the lower edge 42 extends from the second end 36 to the first end 34 of the plate 32. It is, however, appreciated that the particular shape and size of the lightpipe step-strip 30, and the various portions thereof, may vary.

The running board assembly 10 further includes a cover 44 that is fixedly secured to the frame 12 to partially cover the lightpipe step-strip 30. In the current embodiment, the cover 44 includes spaced apart slots 46 extending therethrough. The cover 44, which may be opaque, is situated above the lightpipe step-strip 30 such that the spaced apart strips 38 of the lightpipe step-strip 30 are visible through the corresponding spaced apart elongated slots 46. Thus, the spaced apart strips 38 are visible through the cover 44.

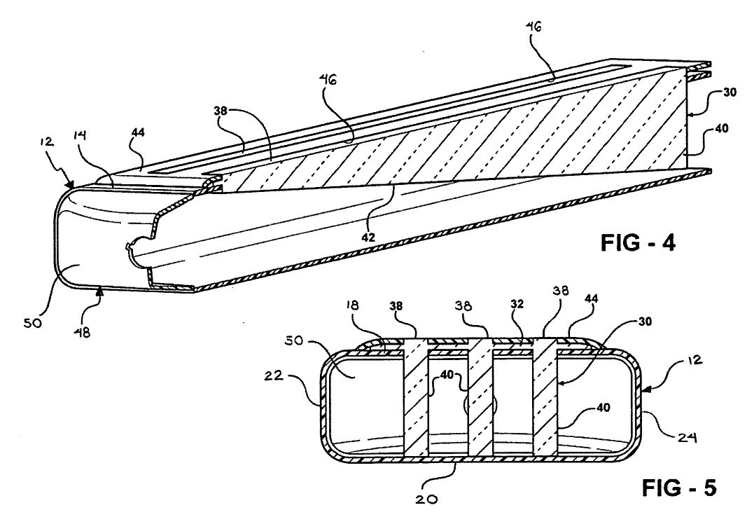

Referring to FIGS. 3 through 6, a lamp assembly, generally indicated at 48, is fixedly secured to the frame 12. The lamp assembly 48 includes a housing 50 that is mounted to the end 14 of the frame 12. It is, however, contemplated that the lamp assembly 48 could be mounted to either the other end 16 of the frame 12 or to both ends 14, 16 of the frame 12. The housing 50 may be mounted to the frame 12 in any of numerous ways. The housing 50 includes an interior portion 52. A clear lens 54 is fixedly secured to the housing 50 to close off the interior portion 52.

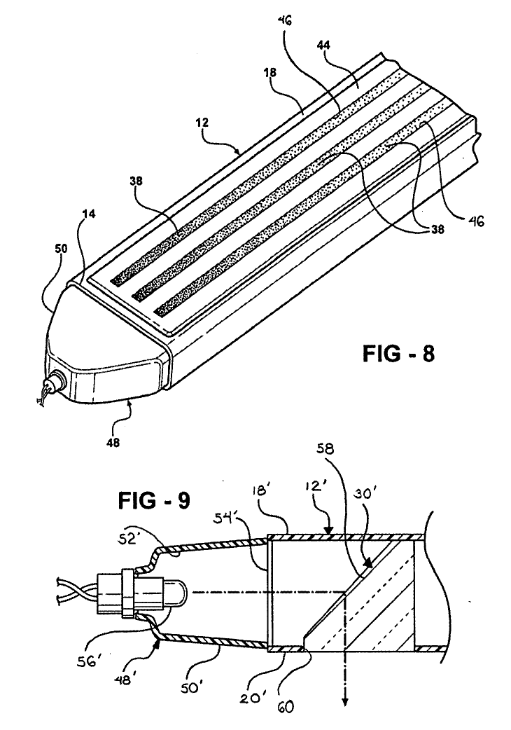

A light source 56 is mounted within the interior portion 52 of the housing 50. The light source 56 is completely encased by the housing 50 and the adjacent frame 12. As a result, the light source 56 is completely shielded from the outside environment and is not susceptible to damage. The light source 56 is operably connected to a power source (not shown.) Upon activation of the lamp assembly 48, the strips 38 of the lightpipe step-strip 30 glow or light up to and the running board assembly 10 is in a lit mode, as shown in FIG. 8.

The light source 56 and the lightpipe step-strip 30 are invisible when the lamp assembly 48 is not activated. As such, vehicle styling may be streamlined and not compromised by lighting geometrical requirements.

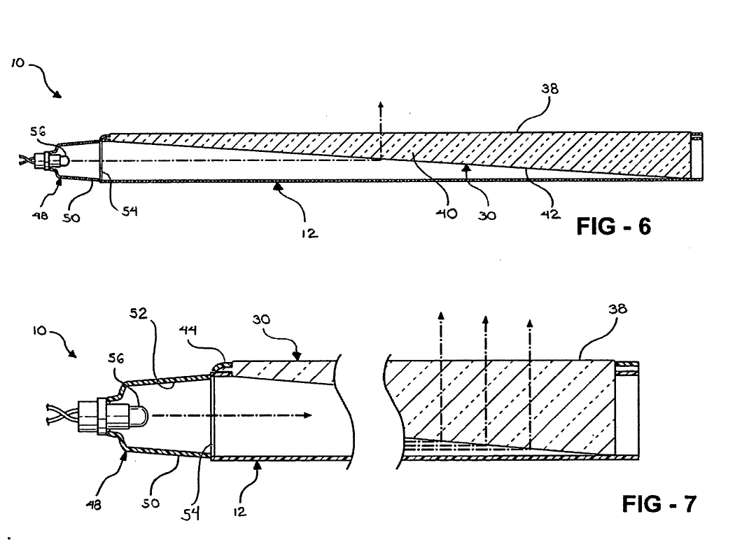

In operation, the light source 56 transmits light to the lightpipe step-strip 30 upon activation of the lamp assembly 48. The downwardly extending members 40 redirect the light upwards, as shown in FIGS. 6 and 7, so that the strips 38 of the lightpipe step-strip 30 light up or glow. The glowing strips 38 are visible through the slots 28 formed in the frame 12 and the slots 46 formed in the cover 44, as shown in FIG. 8, to allow nighttime visibility of the running board assembly 10. The light escaping the frame 12 and the cover 44 allows users who are entering or exiting the motor vehicle to easily locate the running board assembly 10. In addition, there is no glare from the lamp assembly 48, which might otherwise interfere with visibility of the running board assembly 10.

It is appreciated that although only one lightpipe step-strip 30 and one lamp assembly 48 are shown in the Figures and described above, in another embodiment of the invention the running board assembly 10 includes a second lightpipe step-strip 30 and a second lamp assembly 48 at the opposing end 16 of the frame 12.

Moreover, it is contemplated that the lightpipe step-strip 30 may be made from translucent materials in various colors and with highly specular particles suspended within to provide unique styling advantages in both lit and unlit modes.

Referring to FIG. 9, wherein like primed reference numerals represent similar elements as those described above, in a second embodiment of the invention the lightpipe step-strip 30′ includes the plate 32′ having the at least one strip 38′ extending therealong. At least one upwardly extending member 58 extends out from the plate 32′. The bottom surface 20′ of the frame 12′ includes at least one slot 28′ that corresponds to the shape of the at least one strip 38′ so that the at least one strip 38′ is exposed to the outside environment. Upon activation of the lamp assembly 48′, the light source 56′ transmits light to the lightpipe step-strip 30′, which redirects the light downward so that the at least one strip 38′ begins to glow. The light escapes the interior 26′ of the frame 12′ through the at least one slot 28′ in the bottom surface 20′ of the frame 12′ so that the area directly below the running board assembly 10′ is visible. This so-called puddle lamp allows users to see and avoid any standing water, mud, or other undesirable ground conditions below the running board assembly 10′ as they approach the motor vehicle.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. A running board assembly comprising:
a frame having an interior and a top surface, said top surface including at least one slot extending therethrough;
a lightpipe step-strip having a first portion disposed within said interior of said frame and a second portion positioned along said top surface of said frame; and
a lamp assembly fixedly secured to said frame for transmitting light towards said lightpipe step-strip, said first portion of said lightpipe step-strip redirecting the light through said at least one slot in said frame to light said second portion of said lightpipe step-strip and provide nighttime visibility of said running board assembly.

2. A running board assembly as set forth in claim 1 wherein said lightpipe step-strip includes a plate having an upper surface and an opposing lower surface abutting against said top surface of said frame.

3. A running board assembly as set forth in claim 2 wherein said first portion of said lightpipe step-strip includes at least one downwardly extending member fixedly secured to said lower surface of said plate, said at least one downwardly extending member extending through said respective at least one slot in said frame and into said interior thereof.

4. A running board assembly as set forth in claim 3 wherein said second portion of said lightpipe step-strip includes at least one strip fixedly secured to said upper surface of said plate.

5. A running board assembly as set forth in claim 4 including a cover fixedly secured to said frame and disposed above said plate of said lightpipe step-strip.

6. A running board assembly as set forth in claim 5 wherein said cover includes at least one slot extending therethrough and aligned with said at least one strip of said lightpipe step-strip to allow light to escape through said cover.

7. A running board assembly as set forth in claim 2 wherein said second portion of said lightpipe step-strip includes at least one strip fixedly secured to said upper surface of said plate.

8. A running board assembly as set forth in claim 1 wherein said lamp assembly includes a housing fixedly secured to said frame.

9. A running board assembly as set forth in claim 8 wherein said lamp assembly includes a light source disposed within said housing and completely shielded from the outside environment by said housing and said frame.

10. A running board assembly as set forth in claim 1 including a cover fixedly secured to said frame and disposed above said lightpipe step-strip.

11. A running board assembly as set forth in claim 10 wherein said cover includes at least one slot extending therethrough to allow light from said lightpipe step-strip to escape through said cover.

12. A running board assembly for a motor vehicle, said running board assembly comprising:
a frame including a top surface and defining an interior, said frame including at least one slot extending through said top surface;
a lamp assembly fixedly secured to said frame for transmitting light into said interior of said frame;
a lightpipe step-strip including a plate having opposing upper and lower surfaces, said lightpipe step-strip including at least one strip fixedly secured to said upper surface and at least one downwardly extending member secured to said lower surface, said at least one downwardly extending member extending through said at least one slot in said top surface into said interior of said frame for redirecting light from said interior upwards through said slot in said top surface of said frame to light said at least one strip; and
a cover mounted to said frame and disposed above said plate, said cover including at least one slot extending therethrough corresponding to said at least one strip of said lightpipe step-strip to allow visibility of said lighted at least one strip.

13. A running board assembly as set forth in claim 12 wherein said lamp assembly includes a housing fixedly secured to said frame.

14. A running board assembly as set forth in claim 13 wherein said lamp assembly includes a light source disposed within said housing and shielded from said outside environment by said housing and said frame.

15. A running board assembly comprising:
a frame having an interior and a top surface, said top surface including at least one slot extending therethough;
a lightpipe step-strip disposed within said interior of said frame; and
a lamp assembly fixedly secured to said frame for transmitting light towards said lightpipe step-strip, said lightpipe step-strip redirecting the light through said at least one slot in said frame to provide nighttime visibility of said running board assembly.

16. A running board assembly comprising:
a frame including opposing top and bottom surfaces and defining an interior, said bottom surface including at, least one slot extending therethrough;
a lightpipe step-strip disposed within said interior of said frame and visible through said at least one slot in said bottom surface; and
a lamp assembly fixedly secured to said frame for transmitting light into said interior of said frame, said lightpipe step-strip redirecting light from the interior of said frame to said portion of said lightpipe step-strip visible through said at least one slot to allow visibility of die area below said running board assembly.

17. A running board assembly as set forth in claim 16 wherein said lamp assembly includes a housing fixedly secured to said frame.

18. A running board assembly as set forth in claim 17 wherein said lamp assembly includes a light source disposed within said housing and shielded from the outside environment by said housing and said frame.
